(19) United States
(12) Patent Application Publication
(10) Pub. No.: US 2022/0294794 A1
(43) Pub. Date: Sep. 15, 2022

(54) COMPUTERIZED SYSTEM AND METHOD FOR INCREASING, RETAINING AND MAINTAINING NETWORK USER RESOURCE SESSIONS

(71) Applicant: VERIZON MEDIA INC., New York, NY (US)

(72) Inventors: Meizhu LIU, Livingston, NJ (US); Yifan HU, Mountain Lakes, NJ (US); Francis HSU, Santa Clara, CA (US); Lachlan MAXWELL, Ashburn, VA (US); Saurabh TEWARI, Sunnyvale, CA (US); Durga Sankari Sundara MANICKAM, Sunnyvale, CA (US)

(21) Appl. No.: 17/199,884

(22) Filed: Mar. 12, 2021

(51) Int. Cl. H04L 29/06; H04L 29/08; G06N 20/00; G06N 5/04

(52) U.S. Cl. CPC H04L 63/102; H04L 67/22; H04L 63/0853; H04L 63/108; G06N 20/00; G06N 5/04

(57) ABSTRACT

The disclosed systems and methods provide a novel framework that leverages collected logged-in daily active users (LIDAU) data to drive network traffic to network resources, as well as engage these users to continue or remain engaged with the resources through personalization and customization according to their behaviors and patterns. LIDAU data, which is based on a raw data feed of information from network resources and an identified dataset determined from the raw data feed, is used as a basis to increase LIDAU for a specific user or a set of other users. The determined understanding of LIDAU, and its impact on users as well as the network resources the users are interacting with, enables the framework to personalize the resources that are anticipated as being visited by the users in advance of the users visiting them.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to improving the performance of network-based computerized content hosting and providing devices, systems and/or platforms by modifying the capabilities and providing non-native functionality to such devices, systems and/or platforms through a novel and improved framework for creating, increasing and retaining personalized portal sessions.

### BACKGROUND

Over the past few years, there have been major changes in expectations surrounding user data control and privacy online. Most recently, certain companies have changed the way cookies are handled and the manner fingerprints are utilized. For example, some companies have provided tools that allow users to block or clear third party cookies more easily, and restricted browser fingerprinting that is typically used as workaround-s to keep tracking in place when users opt out of third-party cookies. Others have provided a webkit that, by default, prevents a third party entity or website from tracking a user around the internet by blocking cookies.

### SUMMARY

The end of the strict reliance on cookies for tracking and attribution has been a long time coming. Increasingly, logged-in daily active users (LIDAU) data has become critical for personalization and monetization (e.g., increasing revenue and advertising). Not only can LIDAU enhance a user's experience on a site, within an application or domain, but it also enables the site host and/or provider (e.g., Verizon®) to discern more accurate data and interests about its users, which can be utilized for personalization, increased traffic and increased user retention.

This disclosure provides a novel framework that alleviates the current shortcomings in directing, managing and handling network traffic to and from network resources, which include websites, webpages, and their associated applications. Among other benefits, as discussed herein, the disclosed framework leverages collected LIDAU data to drive network traffic to network resources, as well as engage these users to continue or remain engaged with the resources through personalization and customization according to their behaviors and patterns.

LIDAU data, as discussed below, is based on a raw data feed of information from network resources and an identified dataset determined from the raw data feed. The raw LIDAU data includes information describing the information presented to users (referred to as view events) and the users' interactions performed therefrom. The dataset is identified by capturing patterns, login events (e.g., sign-up, sign-in, and the like) and other forms of behavior derived from the raw data.

For example, a Verizon Media® product, e.g., Yahoo!® Finance) comprises a raw data feed of information related to user activity on the site, including user clicks, shares, searches and the like. This raw data is analyzed and it is determined that a specific user logged in, and when logging in clicked the “stay-logged-in” feature, then performed actions X, Y and Z, then went to another website (e.g., a soft-logout). Thus, the raw data and the compiled dataset forms the LIDAU data.

LIDAU data, therefore, can be leveraged to increase LIDAU for a specific user, a set of users, and/or a set of network resources. In some embodiments, the understanding of LIDAU, and its impact on users as well as the network resources the users are interacting with, can enable the framework to personalize the resources that are anticipated as being visited by the users in advance of the users visiting them.

In accordance with one or more embodiments, the present disclosure provides computerized methods for a novel framework for creating, increasing and retaining personalized portal sessions. In accordance with one or more embodiments, the present disclosure provides a non-transitory computer-readable storage medium for carrying out the above mentioned technical steps of the framework's functionality. The non-transitory computer-readable storage medium has tangibly stored thereon, or tangibly encoded thereon, computer readable instructions that when executed by a device (e.g., application server, messaging server, email server, ad server, content server and/or client device, and the like) cause at least one processor to perform a method for a novel and improved framework for creating, increasing and retaining personalized portal sessions.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a block diagram illustrating components of an exemplary system in accordance with embodiments of the present disclosure;

FIGS. 4A-4B are block diagrams illustrating exemplary data flows in accordance with some embodiments of the present disclosure;

FIG. 5 illustrates example non-limiting embodiments in accordance with some embodiments of the present disclosure;

FIGS. 6A-6B are block diagrams illustrating exemplary data flows in accordance with some embodiments of the present disclosure; and

FIG. 7 is a block diagram illustrating an exemplary data flow in accordance with some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, cloud storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with differing protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

As discussed herein, reference to an “advertisement” should be understood to include, but not be limited to, digital media content embodied as a media item that provides information provided by another user, service, third party, entity, and the like. Such digital ad content can include any type of known or to be known media renderable by a computing device, including, but not limited to, video, text, audio, images, and/or any other type of known or to be known multi-media item or object. In some embodiments, the digital ad content can be formatted as hyperlinked multimedia content that provides deep-linking features and/or capabilities. Therefore, while some content is referred to as an advertisement, it is still a digital media item that is renderable by a computing device, and such digital media item comprises content relaying promotional content provided by a network associated party.

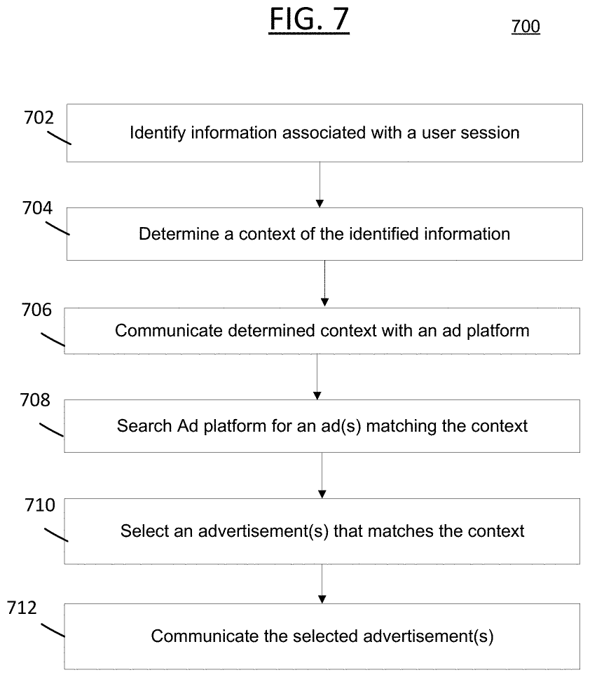

As discussed in more detail below at least in relation to FIG. 7, according to some embodiments, information associated with, derived from, or otherwise identified from, during or as a result of a user session, as discussed herein, can be used for monetization purposes and targeted advertising when providing, delivering or enabling such devices access to content or services over a network. Providing targeted advertising to users associated with such discovered content can lead to an increased click-through rate (CTR) of such ads and/or an increase in the advertiser's return on investment (ROI) for serving such content provided by third parties (e.g., digital advertisement content provided by an advertiser, where the advertiser can be a third party advertiser, or an entity directly associated with or hosting the systems and methods discussed herein).

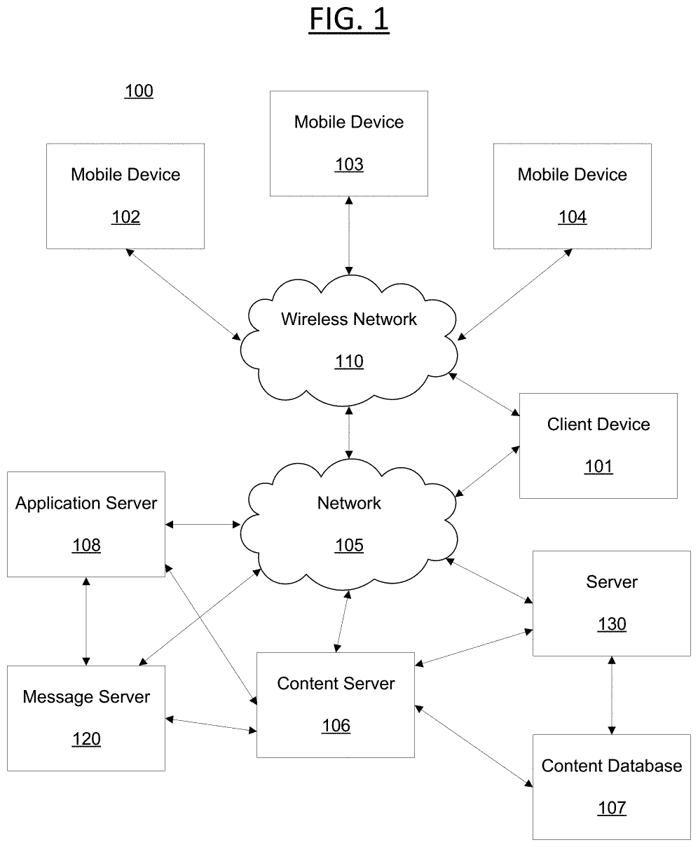

Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106, application (or “App”) server 108, message server 120 and third party server 130.

One embodiment of mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information, as discussed above.

Mobile devices 102-104 also may include at least one client application that is configured to receive content from another computing device. In some embodiments, mobile devices 102-104 may also communicate with non-mobile client devices, such as client device 101, or the like. In one embodiment, such communications may include sending and/or receiving messages, searching for, viewing and/or sharing memes, photographs, digital images, audio clips, video clips, or any of a variety of other forms of communications.

Client devices 101-104 may be capable of sending or receiving signals, such as via a wired or wireless network, or may be capable of processing or storing signals, such as in memory as physical memory states, and may, therefore, operate as a server.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104.

Network 105 is configured to couple content server 106, application server 108, or the like, with other computing devices, including, client device 101, and through wireless network 110 to mobile devices 102-104. Network 105 is enabled to employ any form of computer readable media or network for communicating information from one electronic device to another.

The content server 106 may include a device that includes a configuration to provide any type or form of content via a network to another device. Devices that may operate as content server 106 include personal computers, desktop computers, multiprocessor systems, microprocessor-based or programmable consumer electronics, network PCs, servers, and the like. Content server 106 can further provide a variety of services that include, but are not limited to, email services, instant messaging (IM) services, streaming and/or downloading media services, search services, photo services, web services, social networking services, news services, third-party services, audio services, video services, SMS services, MMS services, FTP services, voice over IP (VOIP) services, or the like. Such services, for example the email services and email platform, can be provided via the message server 120.

Third party server 130 can comprise a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user data. Such sponsored advertising includes monetization techniques including sponsored search advertising, non-sponsored search advertising, guaranteed and non-guaranteed delivery advertising, ad networks/exchanges, ad targeting, ad serving and ad analytics. Such systems can incorporate near instantaneous auctions of ad placement opportunities during web page creation, (in some cases in less than 500 milliseconds) with higher quality ad placement opportunities resulting in higher revenues per ad. That is, advertisers will pay higher advertising rates when they believe their ads are being placed in or along with highly relevant content that is being presented to users. Reductions in the time needed to quantify a high quality ad placement offers ad platforms competitive advantages. Thus, higher speeds and more relevant context detection improve these technological fields.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertising inventory from multiple ad networks. “Ad networks” refers to aggregation of ad space supply from publishers, such as for provision en-masse to advertisers. For web portals like Yahoo!®, advertisements may be displayed on web pages or in apps resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, gender, occupation, and the like) for predicting user behavior, such as by group. Advertisements may be presented to users in a targeted audience based at least in part upon predicted user behavior(s).

Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

In some embodiments, users are able to access services provided by servers 106, 108, 120 and/or 130. This may include in a non-limiting example, authentication servers, search servers, email servers, social networking services servers, SMS servers, IM servers, MMS servers, exchange servers, photo-sharing services servers, and travel services servers, via the network 105 using their various devices 101-104.

In some embodiments, applications, such as mail applications (e.g., Yahoo! Mail®, Gmail®, and the like), instant messaging applications, blog, photo or social networking applications (e.g., Facebook®, Twitter®, Instagram®, and the like), search applications (e.g., Yahoo!® Search), news applications (e.g., Huffington Post®, CNN®, and the like) and the like, can be hosted by the application server 108, message server 120, or content server 106 and the like.

Thus, the application server 108, for example, can store various types of applications and application related information including application data and user profile information (e.g., identifying and behavioral information associated with a user). It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein. Embodiments exist where the TSS functionality can be embodied within servers 106, 108, 120 and/or 130.

Moreover, although FIG. 1 illustrates servers 106, 108, 120 and 130 as single computing devices, respectively, the disclosure is not so limited. For example, one or more functions of servers 106, 108, 120 and/or 130 may be distributed across one or more distinct computing devices. Moreover, in one embodiment, servers 106, 108 and/or 130 may be integrated into a single computing device, without departing from the scope of the present disclosure.

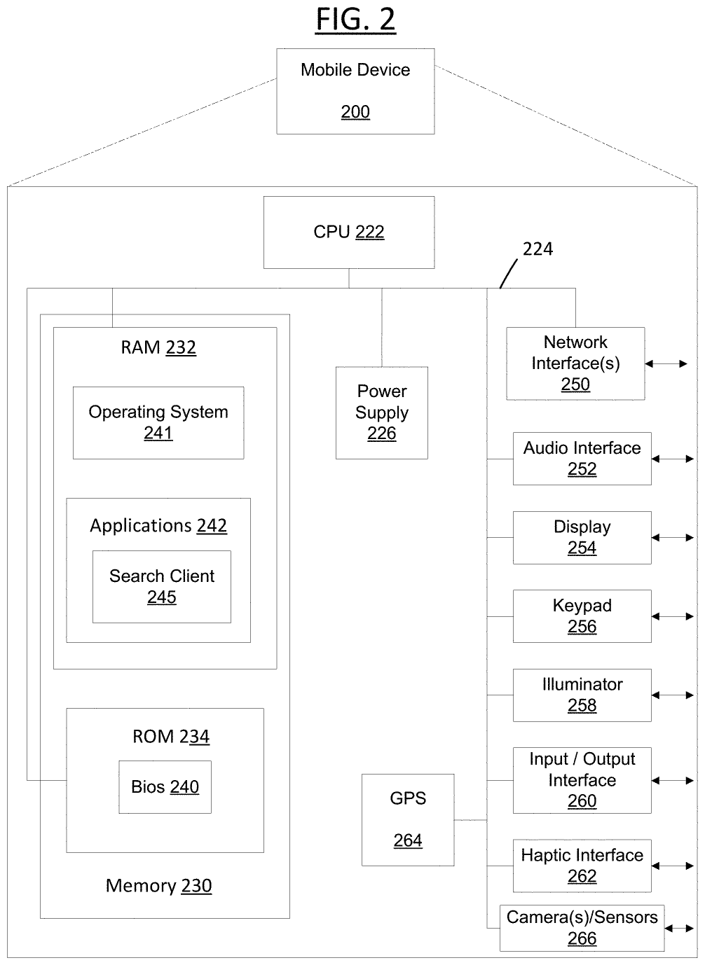

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. Device 200 can include one camera/sensor 266, or a plurality of cameras/sensors 266, as understood by those of skill in the art. Power supply 226 provides power to Client device 200.

Client device 200 may optionally communicate with a base station (not shown), or directly with another computing device. Network interface 250 is sometimes known as a transceiver, transceiving device, or network interface card (NIC).

Audio interface 252 is arranged to produce and receive audio signals such as the sound of a human voice. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. Illuminator 258 may provide a status indication and/or provide light.

Client device 200 also comprises input/output interface 260 for communicating with external. Input/output interface 260 can utilize one or more communication technologies, such as USB, infrared, Bluetooth™, or the like. Haptic interface 262 is arranged to provide tactile feedback to a user of the client device.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. In one embodiment, however, Client device may through other components, provide other information that may be employed to determine a physical location of the device, including for example, a MAC address, Internet Protocol (IP) address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200

Memory 230 further includes one or more data stores, which can be utilized by Client device 200 to store, among other things, applications 242 and/or other information or data. For example, data stores may be employed to store information that describes various capabilities of Client device 200. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 200.

Applications 242 may include computer executable instructions which, when executed by Client device 200, transmit, receive, and/or otherwise process audio, video, images, and enable telecommunication with a server and/or another user of another client device. Applications 242 may further include search client 245 that is configured to send, to receive, and/or to otherwise process a search query and/or search result.

Having described the components of the general architecture employed within the disclosed systems and methods, the components' general operation with respect to the disclosed systems and methods will now be described below.

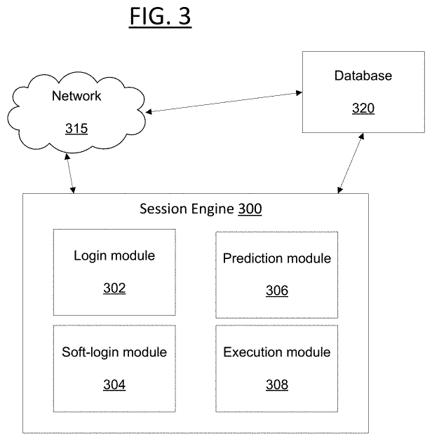

FIG. 3 is a block diagram illustrating the components for performing the systems and methods discussed herein. FIG. 3 includes session engine 300, network 315 and database 320. The session engine 300 can be a special purpose machine or processor and could be hosted by a cloud server (e.g., cloud web services server(s)), messaging server, application server, content server, social networking server, web server, search server, content provider, third party server, user's computing device, and the like, or any combination thereof.

According to some embodiments, session engine 300 can be embodied as a stand-alone application that executes on a user device. In some embodiments, the session engine 300 can function as an application installed on the user's device, and in some embodiments, such application can be a web-based application accessed by the user device over a network. In some embodiments, the session engine 300 can be installed as an augmenting script, program or application (e.g., a plug-in or extension) to another application or portal data structure.

The database 320 can be any type of database or memory, and can be associated with a content server on a network (e.g., content server, a search server or application server) or a user's device (e.g., device 101-104 or device 200 from FIGS. 1-2). Database 320 comprises a dataset of data and metadata associated with local and/or network information related to users, services, applications, content and the like.

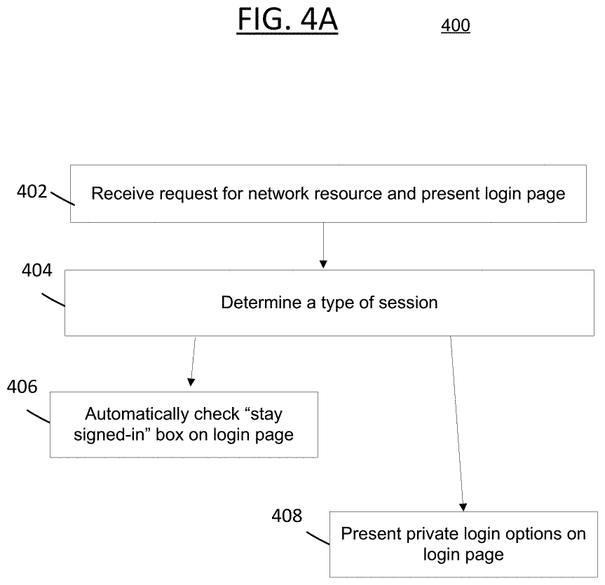

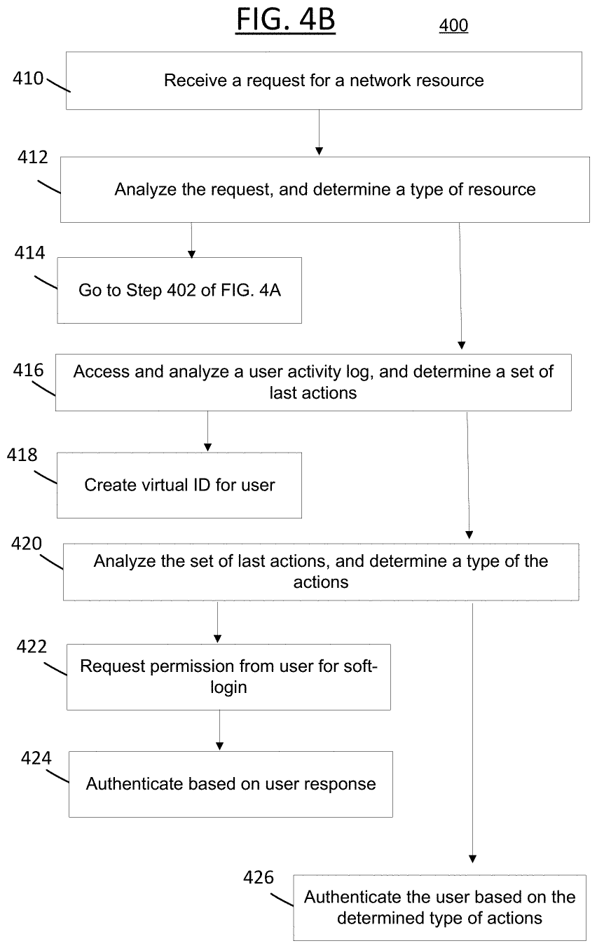

In some embodiments, such information can be stored and indexed in the database 320 independently and/or as a linked or associated dataset. An example of this is look-up table (LUT) illustrated in FIG. 4, as discussed below. As discussed above, it should be understood that the data (and metadata) in the database 320 can be any type of information and type, whether known or to be known, without departing from the scope of the present disclosure.

According to some embodiments, database 320 can store data for users, e.g., user data. According to some embodiments, the stored user data can include, but is not limited to, information associated with a user's profile, user interests, user behavioral information, user patterns, user attributes, user preferences or settings, user demographic information, user location information, user biographic information, and the like, or some combination thereof. In some embodiments, the user data can also include user device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 320 can be any type of information related to a user, content, a device, an application, a service provider, a content provider, whether known or to be known, without departing from the scope of the present disclosure.

According to some embodiments, database 320 can store data and metadata associated with users, messages, images, videos, text, products, items and services from an assortment of media, applications and/or service providers and/or platforms, and the like. Accordingly, any other type of known or to be known attribute or feature associated with a message, data item, login, logout, website, application, communication (e.g., a message) and/or its transmission over a network, a user and/or content included therein, or some combination thereof, can be saved as part of the data/metadata in datastore 320.

As discussed above, with reference to FIG. 1, the network 315 can be any type of network such as, but not limited to, a wireless network, a local area network (LAN), wide area network (WAN), the Internet, or a combination thereof. The network 315 facilitates connectivity of the session engine 300, and the database of stored resources 320. Indeed, as illustrated in FIG. 3, the session engine 300 and database 320 can be directly connected by any known or to be known method of connecting and/or enabling communication between such devices and resources.

The principal processor, server, or combination of devices that comprise hardware programmed in accordance with the special purpose functions herein is referred to for convenience as session engine 300, and includes login module 302, soft-login module 304, prediction module 306 and execution module 308. It should be understood that the engine(s) and modules discussed herein are non-exhaustive, as additional or fewer engines and/or modules (or sub-modules) may be applicable to the embodiments of the systems and methods discussed. The operations, configurations and functionalities of each module, and their role within embodiments of the present disclosure will be discussed below.

Turning to FIGS. 4A-4B, Process 400 details non-limiting embodiments for increasing LIDAU for network resources. As discussed herein, network resources (also referred to as properties, interchangeably) can include, but are not limited to, websites, webpages, domains, platforms, applications and the like. For example, Process 400 details non-limiting embodiments for improving LIDAU for a website and/or its associated application; therefore, users on a desktop visiting the website via their browser and users opening the website's application on their devices can be increased according to the systems and methods discussed herein.

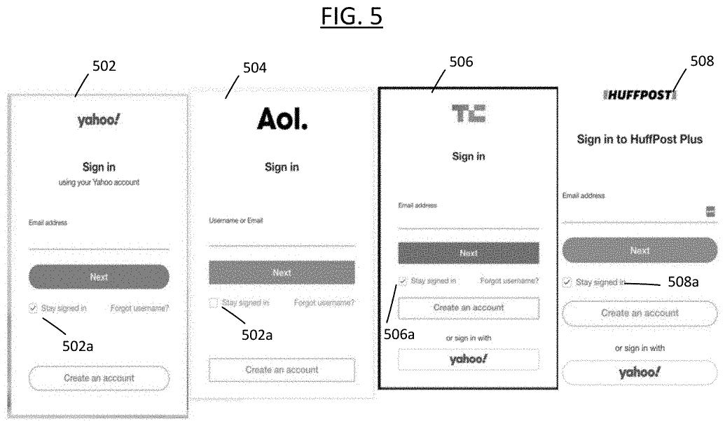

According to some embodiments, LIDAU can be increased by automatically checking the stay-signed in box by default. As illustrated in FIG. 5, when a user visits a network resource, they are typically presented with a sign-in page that prompts the user to enter their login credentials (e.g., username, password, pin code, biometric data, 2-factor authentication information, and the like).

As illustrated in FIG. 5, when user visits sign-in pages 502-508, they are presented with this opportunity to login. As mentioned above, LIDAU can be increased by automatically “opting-in”, or having the “stay-signed in” box (e.g., items 502a-508a, respectively) checked. Thus, when a user logs into a web portal, or is granted access to a domain and its network resources, a browser cookie (BCookie(s)) can be assigned as “logged in”, and it can be maintained as logged in even if/when the user browses away from that portal or domain. This enables the user to remain logged in, thereby retaining capabilities to track the user's actions, and eases the manner the user can revisit the site, which increases LIDAU, as discussed below.

Therefore, turning to FIG. 4A, Process 400 details Steps 402-408 which provide non-limiting example embodiments of how a login screen is modified from general convention to enable increased LIDAU data. According to some embodiments, Steps 402-408 are performed by login module 302 of session engine 300.

Process 400 of FIG. 4A begins with Step 402 where a user requests access to a network resource, and in response, is presented a login page user interface (UI). For example, as illustrated in FIG. 5, a user opens his/her browser and enters the uniform resource locator (URL) for a website—e.g., Yahoo.com—item 502 of FIG. 5. The login page 502 is presented to the user on his/her device. As discussed above, such page(s) can be presented by a user opening an application on his/her device (e.g., a Yahoo!® application for login page 502).

In Step 404, a determination is made as to a type of session. That is, for private devices, for example with one account per IP address, it can be determined that the session is private (e.g., that a user is on his/her personal device and is securely performing computing operations). For shared devices, where many accounts share one IP address, it can be determined that the session is not-private (e.g., a user is computing on a public device, for example a library or café; a user is using another person's device (e.g., borrowing a friend's device), and the like).

According to some embodiments, the determination performed in Step 404 can be based on information included in or associated with the request from Step 402. For example, the information can include, but is not limited to, device information, network information, geographic information, and the like. In some embodiments, the request from Step 402 can be analyzed and the information that dictates whether a session is private or shared can be identified. In some embodiments, such analysis and identification can be performed by any known or to be known message analysis technique, algorithm, classifier or mechanism, including, but not limited to, computer vision, Bayesian network analysis, Hidden Markov Models, artificial neural network analysis, logical model and/or tree analysis, data mining, and the like.

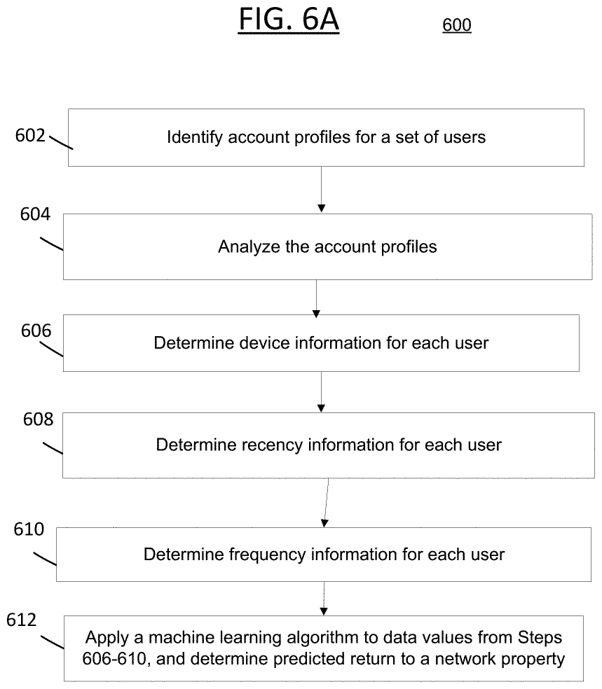

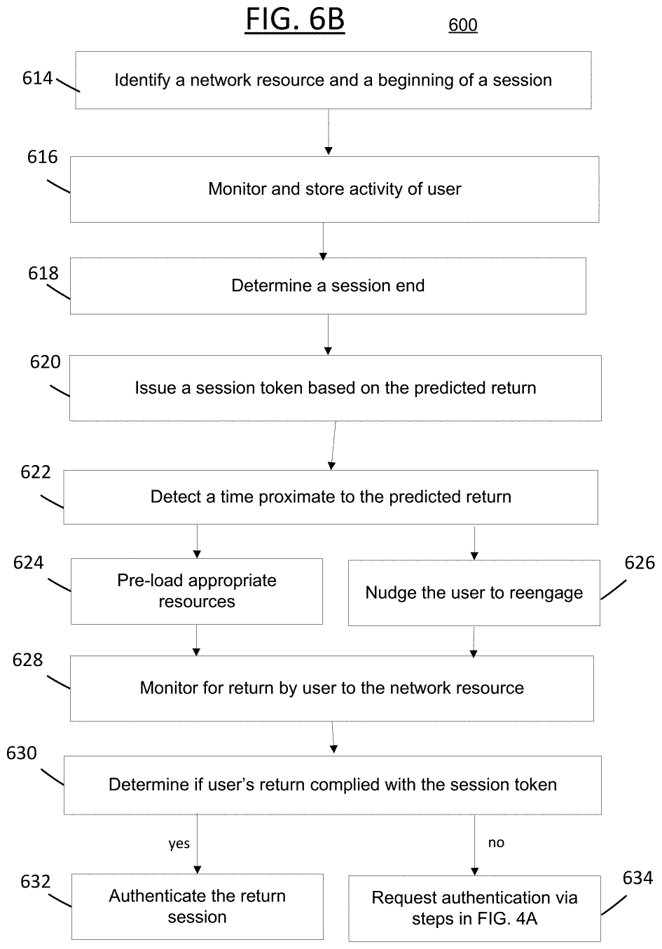

From Step 404, when it is determined that the type of session is private, then Process 400 proceeds to Step 406, where the “stay signed in” box is automatically checked. In some embodiments, rather than checking the “stay signed in” box, this feature can be removed from the login page's UI, and a login will be treated as if the box was checked. In either embodiments, the “stay-signed in” box enables a BCookies to be authenticated for the user's browsing session. In some embodiments, when the user closes the browser, the BCookies are purged; however, in some embodiments, it can remain operational for subsequent authentication when the user re-initiates the browser/application and/or re-logs back in (as discussed below in relation to FIGS. 6A-6B).

When it is determined in Step 404 that the type of session is shared, private login options can be presented to the user. Step 408. For example, the user can be presented with options to login as a “guest”. Thus, for example, when the user logs in using “guest” mode, the browsing activity (e.g., BCookie) is deleted from the computer when the user logs out or closes the browser/application.

According to some embodiments, LIDAU can be increased by performing a non-binary login and/or a soft logout. Some websites do not adhere to the strictest security standards as they do not require a login to view the content hosted thereon. For examples, such websites can include, but are not limited to, news, search, lifestyle, sports, front pages, entertainment, and the like. Non-login users visiting such sites can view the content; however, this raises the issue of being unable to track such users despite the lack of verified and/or authenticated BCookies.

Thus, turning to FIG. 4B, as discussed herein in relation to Steps 410-426 of Process 400, which are performed by soft-login module 304 of session engine 300, actions a user performs respective to their last mail (or messaging) account activity can serve as proper authentication of BCookies for user tracking, which results in increased LIDAU from a previously untapped situation for non-logged in users.

Process 400 of FIG. 4B begins with Step 410 where a request for access to network resource is received. This request can include similar information and be performed in a similar manner as discussed above in relation to Step 402 of FIG. 4A.

In response to the received request, engine 300 performs Step 412 where the request and/or information related to the network resource are analyzed, and the type of resource being requested is determined. In some embodiments, the type of the resource indicates whether the resource requires a login to access its content or whether the resource allows non-logged in users to view its content. In some embodiments, the BCookie for the resource can be analyzed as it can indicate the type.

In some embodiments, the analysis and identification of the request, the network resource information (including the BCookie) can be performed by any known or to be known message analysis technique, algorithm, classifier or mechanism, including, but not limited to, computer vision, Bayesian network analysis, Hidden Markov Models, artificial neural network analysis, logical model and/or tree analysis, and the like.

Process 400 of FIG. 4B proceeds from Step 412 to Step 414 when the determined (or detected) type of network resource requires a login. Thus, in Step 414, Process 400 proceeds back to Step 402 of FIG. 4A, where a user can enter his/her credentials, as discussed above.

Process 400 proceeds from Step 412 to Step 416 when the determined (or detected) type of network resource does not require a login (e.g., enables non-logged in users access to at least a portion of its content). In Step 416, a user activity log for the user is identified and is analyzed to determine the last action(s) the user performed (e.g., a set of last actions, for example, the previously visited website(s) and/or set of actions performed therein/thereon during a browsing session (either current or previous)). In some embodiments, the user log can include information for a predetermined set of websites, actions, period of time, devices used, locations where such actions occurred, and the like, or some combination thereof.

In Step 416, the user log is analyzed and information related to the last action(s) is identified and analyzed. Step 416 results in a determination of whether the request in Step 410 is proximate to a recent login (e.g., a successful login) by a user to another high-security property. In other words, Step 416 provides an indication whether the user had a login event during the current (or n previous) browsing session.

In some embodiments, the analysis and identification can involve determining whether a BCookie from a high-security property (e.g., mail, or any other property that requires a secure login procedure to access its hosted content) is authenticated and active in association with the user's browsing session. In some embodiments, the analysis and identification performed in Step 416 can be performed in a similar manner as discussed above in relation to Step 412.

When last action was not subject to, nor proximate to a high-security login event (e.g., the browsing session did not involve logging into any web portal or website), then Process 400 proceeds from Step 416 to Step 418. In Step 418, engine 300 can develop and leverage a “virtual” ID for the user, as discussed below.

When the last action performed by the user was, for example, performed during a browsing session that involved a previous login to another high-security property (e.g., mail account), the Process 400 proceeds from Step 416 to Step 420. In Step 420, the last action(s) and the information surrounding such action from the user log are analyzed, and such analysis is performed in a similar manner as discussed above in relation to Steps 412 and 416.

When, from Step 420's analysis, it is determined that the last action was performed as logged-in to a high-security property (e.g., mail) and no explicit logout was done by the user in between the login and Step 410, Process 400 proceeds from Step 420 to Step 426. In Step 426, the BCookie for the requested resource in Step 410 is authenticated and is tracked and treated as a login event (despite the resource in Step 410 not explicitly requiring a login). This can be viewed as a “soft-login” (or a less secure login), and enables LIDAU to increase due to the explicit tracking of the user as a logged in user.

When, from Step 420's analysis, it is determined that an explicit logout was performed between the login and Step 410, then Process 400 proceeds from Step 420 to Step 422. In Step 422, a request is communicated, presented and/or displayed to the user that requests permission from the user to treat the BCookie for the network resource as “logged in”. In some embodiments, such requests can be communicated directly to the user and request whether the explicit sign-out be solely for that previously accessed high-security property (and not for the entire browsing session).

Should the user accept the request, in Step 424, the BCookie for the requested network resource from Step 410 is authenticated. In some embodiments, the acceptance can be performed automatically based on user preferences or settings, or based on a received input approving the request by the user.

For example, if a user logged into his/her mail account, then logged out, then performed Step 410, the user can be prompted with an option to check/select “sign out of mail” option. Should the user accept, then the resource accessed in Step 410 is treated as logged-in session with the requisite BCookie.

Thus, Steps 422-424 enable a user to choose whether they want to logout from a current or previous property or entirely during their browsing session.

According to some embodiments, as discussed above, engine 300 can proactively create “virtual” ID or account for active non-login users. That is, for users that visit online properties of a service provider (e.g., Verizon Media) and do not have an account with that provider (e.g., no Verizon®, AOL®, Yahoo! ®), then engine 300 can create a “virtual” account for those users. The account can be based upon, and include information indicating the user's IP addresses, device information and browser information. The information can be encrypted and stored in a created user profile. When these users are detected as active on proprietary properties of the service provider, the account can be retrieved and active BCookies can be associated therewith so that active tracking of the user can be performed. Currently, there are about 14 million BCookies daily for non-logged in users. Data collected from their activities can be utilized to better personalize user experiences for existing users (e.g., advertising and customization), as well as draw in other users that do not currently have accounts. Moreover, such data can be provided to third parties for customization of their ad platforms.

Turning to FIGS. 6A-6B, Process 600 details non-limiting example embodiments for predicting when users will return to a network resource (e.g., a Verizon Media® website(s) or application(s)) so that a personalized session extension can be offered to secure and better serve their accounts.

According to some embodiments, Process 600 provides a user event activity prediction framework that can predict when a user returns to a network resource, which can include a website, a platform and the like (e.g., a Verizon Media property). As discussed herein, this not only will help improve user experience which involves the increase in LIDAU, but also enhances the security of the user's account.

Thus, since it is understood that most users may come for a provider's sites, they typically stay within the provider's pavilion of properties for the experience (e.g., customized content, recommended content, and the like). Just like the hospitality industry, if a system can anticipate the needs of guests before they arrive and/or before they are expressed by the users, the system can enhance each user's experience and engender loyalty.

Thus, Process 600 through Steps 602-634 of FIGS. 6A-6B provides a novel framework and functionality for predicting a user's next session, in that such anticipation breeds the ability for the session host to optimize the platform for increased performance and stricter security.

A user session is based upon a time duration from a starting authenticated user activity event on a network until an end event, which is followed by a window of no user activity events seen on the network (or on a site(s), platform(s) or service(s)). Predictions of the presence or absence of a user in the upcoming time windows have value for many potential optimizations. If a user will begin a session soon, engine 300 can set up an environment that is ready to serve the needs of the user.

According to some embodiments, for mobile apps, background tasks can refresh data ahead of app usage to provide fresh data and minimize time spent for the application to launch. The refresh occurs while the apps are idle so that they are immediately ready for a user's return session. Likewise, on the server side, in some embodiments, user data is prepared and loaded in preparation for use in delivery.

According to some embodiments, while work is being performed in the background to prepare for a user's return, engine 300 can also execute functions that suspend maintenance activity and freeze operations that consume resources and interfere with the user experience.

These actions, as evidenced from the below discussion, help improve user experience and can increase LIDAU, which in turn increases revenue since logged-in users generate more revenue compared to non-logged-in users.

According to some embodiments, after a user authenticates with the centralized identity services (e.g., logs in and begins session), an authenticated session is established with the corresponding information being stored in cookies or tokens, depending on the property or client (referred to as session credentials). The session credentials are then presented to properties the user visits to carry out activities with an authenticated user account session. The session credentials carry an expiration time, after which the user needs to re-establish the session with the centralized identity service with a redirect in the browser or additional API calls to the extension/refresh service. In some embodiments, the credentials can carry a predetermined validity period (e.g., 14 days). In some embodiments, the period can fluctuate based on activity of a user—for example, it can be extended for more active users and reduced for less active users.

There is, however, that the chance that session credentials can be intercepted via attacks against the browser or apps. Possession of the session credentials allows for almost any operation the user is authorized to perform, including reading private information, to be hijacked by a malicious actor. Ideally, applying the security principle of “least privilege” would create session credentials that are only valid a minimal amount of time. If the user is still active in the sessions, it would require a call to refresh the validity with a cost of the network call to do so. This potentially degrades the user experience with this redirect in the middle of a session. Therefore, a balance of user experience and security must be struck, and is realized by the disclosed framework's session credentials having a lifetime corresponding to the period of a user's active session (and no longer).

For example, if it is predicted that a user will not return for the next 24 hours, the framework can build and deploy a strategy to increase the security for the user: for example, the framework can optimize the session duration logic to this set of users (personalized session duration) by issuing short session credentials. Attackers who steal the session credentials will not gain extended access to the accounts. When the session credentials expire, both the user and attacker need to return to the identity services for a refresh of the session in order to continue. Upon that refresh request, an identity system operating in connection with the platform can perform a risk based analysis to determine whether or not to issue a new session token without requiring the user to reauthenticate. The shorter the duration of a session, the sooner the risk based system can disrupt attacker access.

Accordingly, the framework can increase security levels for the accounts during this window. If there is an authentication attempt when it is not expected, risk thresholds can be adjusted dynamically to challenge the attempt and require higher levels of proof in case it is not from the account owner.

Thus, as discussed below, a user's activity behavior and patterns are analyzed, and a determination is made regarding when a user will most likely return after departing a session. The session credentials can be adjusted accordingly, which enables an optimized experience as the session is ready for the user when he/she returns, and also provides added security in that between sessions, the user's account is protected against unsolicited, malicious attacks.

Turning to FIG. 6A, Steps 602-612 of Process 600 are detailed, and are performed by prediction module 306 of session engine 300.

Process 600 beings with Step 602 where account profiles for a set of users are identified. The set of users can be a selected number of users, a number of users that visit a website within a time frame, a number of users that login within a time frame, or a number of visitors to a specific property for a time period (e.g., daily, weekly and the like). In some embodiments, the information in the profiles can correspond to a period of activity (e.g., 21 days). As discussed above in at least relation to FIG. 3, the profile comprises data related to a user, his/her devices, network data, his/her activities, demographics and location data, and the like.

In Step 604, the account profiles are analyzed. In some embodiments, such analysis can be performed by any known or to be known message analysis technique, algorithm, classifier or mechanism, including, but not limited to, computer vision, Bayesian network analysis, Hidden Markov Models, artificial neural network analysis, logical model and/or tree analysis, data mining, and the like.

In Step 606 a determination is made regarding device information for each user, which indicates a device type(s) and a number of device types per user. This determination is based on the analysis from Step 604. A device type relates to the type of device that a user uses to login to a property or account (e.g., mobile device, desktop, and the like). The number of device types provides an indication as to how many devices a user uses to login to his/her account. For example, user X logs in to his account from his smartphone, home laptop and work desktop. Therefore, user X would have 2 types of computers, and one of those types has a quantity of 2 (the home and work personal computer (PCs)).

In Step 608, which is also based on the analysis from Step 604, recency information for each user in the set of users is determined. The recency information includes a recency value and a recency score. The recency value provides information indicating the last time each user logged into a property/account. This can indicate when the last time each user, and a cluster of users, has logged in, and how long it has been since they last did.

After having the recency for each user, a K-means clustering algorithm is applied to assign a recency score. In order to do so, the number of clusters needed for the K-means algorithm is required, which is based on an applied Silhouette coefficient that indicates the optimal cluster number for optimal inertia. The Silhouette ranges from −1 to +1, where a high value indicates that the object is well matched to its own cluster and poorly matched to neighboring clusters. If most objects have a high value, then the clustering configuration is appropriate. If many points have a low or negative value, then the clustering configuration may have too many or too few clusters.

The Silhouette Coefficient is calculated using the mean intra-cluster distance a and the mean nearest-cluster distance b for each sample. Thus, the Silhouette Coefficient for a sample is:

(b−a)/max(a,b), (Equation 1)

where b is the distance between a sample and the nearest cluster that the sample is not a part of. The mean Silhouette Coefficient over all samples can be computed and used as a metric to judge the number of clusters.

After determining the clusters, they are ordered by the average recency in the cluster decreasingly, where each user is assigned to a cluster. As a result, the cluster represents the recency score. The higher the score for a cluster/user, the more active the user is. Compared with recency alone, recency and its accompanying recency score is more robust to noise and outliers due to the randomness of the users' activities.

In Step 610 a determination regarding an activity level (or value) for each user is performed. In other words, frequency information which provides a frequency value that describes how frequent a user visits a specific property (e.g., platform or website). A typical feature is the number of times a user visited a specific property in a time period. According to some embodiments, the frequency value is based on and/or includes the following features:

i) Number of active days per hour: for each hour of the day, the number of active days is identified. In some embodiments, this can be based on an analyzed period of data—for example, a 21 day period of historical data for each user (note, the 21 day period is used for all other frequency period; however, it should not be construed as limiting). People are generally more active at some hours compared with other hours. For example, some people are more active from 8:00 to 11:00, and some people are more active from 18:00 to 23:00. Note, in some embodiments, a conversion of time to a user's local time zone may not be performed; however, time zones can be used as a feature, and a machine learning algorithm, such as XGBoost, can account for such auto-conversion.

ii) Number of properties the user has visited per hour: for each hour of the day (e.g. 1:00 am), the number of properties a user has visited is identified. This is similar to the “Number of active days per hour” as mentioned above.

iii) numviewsperh: the number of page views a user has made during the past 21 days for each hour of the day.

iv) numhoursperw: the number of distinct hours of the day (0:00 am-23:00 pm) the user has been active. The maximum value is 24 meaning the user has at least one activity for all the hours during the past 21 days. The minimum value is 0, meaning the user had no activity at all.

v) numdayhoursperw: number of active hours per day of the week: For each day (Monday to Sunday) of the week, the total number of hours the user has been active is identified.

vi) numdaysperw: the number of active days which is a specific day of the week (e.g. Monday) for a user in the past 21 days.

vii) numptyperw: the number of properties the user has visited which happened on a specific day of the week.

viii) numviewsperw: the number of page views the user has made which happened on a specific day of the week.

ix) numhours: the number of unique hours the user has been active.

x) numdayhours: the number of unique hours of the day the user has been active.

xi) numweekdays: the number of unique “day of the week” the user has been active. The maximum number is 7 since there are 7 days in a week and the minimum number is 0.

xii) numdays: the number of days the user was active on in the past 21 days. The maximum value is 21 meaning the user has been active every day in the past 21 days, and the minimum value is 0.

xiii) numpty: the total number of properties the user has visited during the past 21 days.

xiv) numviews: the total number of page views the user has had in the past 21 days.

xv) Demographic features such as age, gender and time zone. In some embodiments, if such information is not available, a default value to represent that information can be used.

xvi) Number of hours and days between the last x visits, where x is a predetermined number (e.g., 3).

xvii) Mean standard deviation of the time difference between visits for each user.

Continuing with Process 600 of FIG. 6A, Step 612 involves engine 300 applying a machine learning algorithm to the data values from Steps 606, 608 and 610 (device information, recency information and frequency information, respectively) and determining a predicted return to a property (or resource) by the set of users (e.g., predicted return information). According to some embodiments, the determination in Step 612 provides a prediction indicating at least when a user will return (e.g., how long between sessions a user will be inactive—e.g., 1 hour, 24 hours, 1 week, and the like) and/or to which property such return will be consummated.

According to some embodiments, the applied machine learning algorithm can be a classification algorithm or model, such as the XGBoost algorithm, with evaluation metrics including the area under the receiver operating characteristic (ROC) curve (Area Under Curve (AUC)), mean average precision (MAP), precision, recall and F−1 score.

According to some embodiments, the determination in Step 612 can involve labelling a user based on his/her predicted return to a session. The labelling enables the creation, extension, termination and securing of session credentials (or session cookies (e.g., a BCookie)).

In some embodiments, the user, and by association, the user's account (or profile) and/or session cookies can be subject to binary labelling, where when the labeling value is set to “1” for a time period for return, it is expected that the user will return at that time period; and “0” for an unexpected return for that time period. For example, if a user is expected to return to a session in 1 hour, the label for “1 hour” for that user is set to “1”. In some embodiments, here, the labels for the other time periods, e.g., 4 hours, 8 hours, 24 hours and/or 48 hours, for example, will be set to “0” to indicate that the user is not expected to next be back that these time frames (because he/she is expected back in 1 hour).

Thus, upon learning that a user will return in Xhours (from Step 612), the framework can prepare the property by pre-launching the apps or pre-loading the configuration files for a property in order to enable a fast load time for the user, as discussed below in relation to FIG. 6B. The session can be optimized, and during the “down time” between the last and next sessions, the users account can be protected, as discussed above.

Turning to FIG. 6B, Steps 614-632 of Process 600 are detailed, which are performed by execution module 308 of session engine 300, and corresponds to how a predicted return for a user is effectuated by engine 300.

Process 600 of FIG. 6B begins with Step 614 where a network resource (also referred to as a property, interchangeably) is identified. The identification of the resource is similar to the processing discussed above in relation to Process 400 of FIGS. 4A-4B, where a user logs into an account.

In Step 616, the activity of the user is monitored, and is stored in his/her account profile. In Step 618, the monitoring provides an indication that the user has ended his/her session (e.g., has logged out, closed the browser, or in some embodiments, opened another application or visited another resource/property). Thus, in Step 618 it is determined that the user has ended his/her session.

In some embodiments, Step 618 can trigger the steps of FIG. 4B above, where a user visits another site after a login event, as discussed above.

Continuing with Process 600 of FIG. 6B, from Step 618, Step 620 is executed where a session token is issued for the user. The session token's issuance is based on the computations performed by engine 300 in Steps 602-612 for the user. Thus, based on the user's expected return, and the corresponding labelling of the user's account (e.g., Xhours until a return), the session token can be defined accordingly. The token can indicate an activity or authentication level that corresponds to the expected return, so that should it be pirated by a malicious actor prior to the expected return, it will not render the user's account vulnerable to attack.

In Step 622, a time proximate to the predicted return is detected. A time proximate corresponds to a threshold amount of time to the expected return. For example, if the expected return is 1 hour, a time proximate can be 5 minutes before the 1 hour marker. The time proximate threshold can be proportional to the predicted return.

Upon the detection of the time proximate, engine 300 can perform Steps 624 and/or 626. In Step 624, the applications, pages, content, configuration files and/or background information for the property can be pre-loaded (e.g., the corresponding, appropriate or associated resources), as discussed above. In Step 626, engine 300 can nudge the user by sending him/her messages (which can include ads, content, links, critical emails or other forms of interactive data) that will cause the user to act and reengage or revisit the resource.

In some embodiments, engine 300 can be configured to monitor a user's incoming messages to his/her inbox, and hold messages that are determined crucial to the user (e.g., not send them to the inbox and store them until a later determined time). This can increase the likelihood that the user will see these crucial messages. For example, upon determining the expected return for a user (from Step 612 above), engine 300 can monitor inbound messaging traffic for the user. Upon receiving a message, it can be parsed, analyzed and its contents categorized, such that its context is determined. Should it be determined to be critical (e.g., a bill, or urgent message from a spouse, for example), then engine 300 can store it in cache until the time proximate to the expected return.

Continuing with Process 600 of FIG. 6B, from Steps 624 and/or 626, Step 628 is performed which involves monitoring for the user's return (e.g., the user revisiting the network resource from Step 614). In Step 630, if it is determined that the user returned at a time within a threshold period of time relative to the time period corresponding to the session token (in Step 620), then the user's return session can be authenticated. Step 632. In some embodiments, such reauthentication can be performed according to the embodiments discussed above in relation to FIG. 4B. If, in Step 630, it is determined that the user returned at a time outside of the threshold period of time to the time period corresponding to the session token (in Step 620), then the user can be presented with the options for reinstating his/her session, in a similar manner as discussed above in relation to FIG. 4A (e.g., requiring the user to authenticate themselves). Step 634. In some embodiments, Step 634 can be performed via the soft-login steps of FIG. 4B.

FIG. 7 is a work flow process 700 for serving or providing related digital media content based on the information associated with a user session, as discussed above in relation to FIGS. 4A-6B. In some embodiments, the provided content can be associated with or comprising advertisements (e.g., digital advertisement content). Such information can be referred to as “session information” for reference purposes only.

As discussed above, reference to an “advertisement” should be understood to include, but not be limited to, digital media content that provides information provided by another user, service, third party, entity, and the like. Such digital ad content can include any type of known or to be known media renderable by a computing device, including, but not limited to, video, text, audio, images, and/or any other type of known or to be known multi-media. In some embodiments, the digital ad content can be formatted as hyperlinked multi-media content that provides deep-linking features and/or capabilities. Therefore, while the content is referred as an advertisement, it is still a digital media item that is renderable by a computing device, and such digital media item comprises digital content relaying promotional content provided by a network associated third party.

In Step 702, session information is identified. This information can be derived, determined, based on or otherwise identified from the steps of Processes 400 and/or 600, as discussed above. For example, which BCookies are authenticated, which sites are revisited, and the like.

For purposes of this disclosure, Process 700 will refer to single user browsing or application session for a single user; however, it should not be construed as limiting, as any number of sessions, for any number of browsers and/or applications, over any amount of time for any number of users, can form such basis, without departing from the scope of the present disclosure.

In Step 704, a context is determined based on the identified session information. This context forms a basis for serving content related to the session information. For example, the context can be determined based on analysis of the websites the user visited during an authenticated session. For example, which BCookies were authenticated, from which the context (e.g., topic or category of content) is derived therefrom. The identification or determination of a context can be performed via the analysis techniques described above in relation to at least Step 412.

In some embodiments, the identification of the context from Step 704 can occur before, during and/or after the analysis detailed above with respect to Processes 400 and 600, or it can be a separate process altogether, or some combination thereof.

In Step 706, the determined context is communicated (or shared) with a content providing platform comprising a server and database (e.g., content server 106 and content database 107, and/or advertisement server 130 and ad database). Upon receipt of the context, the server performs (e.g., is caused to perform as per instructions received from the device executing the engine 300) a search for a relevant digital content within the associated database. The search for the content is based at least on the identified context.

In Step 708, the server searches the database for a digital content item(s) that matches the identified context. In Step 710, a content item is selected (or retrieved) based on the results of Step 708.

In some embodiments, the selected content item can be modified to conform to attributes or capabilities of a device, browser user interface (UI), page, interface, platform, application or method upon which a user session will be initiated, continued and/or retained, and/or to the application and/or device for which a session is occurring or is to occur.

In some embodiments, the selected content item is shared or communicated via the application or browser the user is utilizing to consume the network resource. Step 712.

In some embodiments, the selected content item is sent directly to a user computing device for display on a device and/or within the UI displayed on the device's display (e.g., within the browser window and/or within an inbox of the high-security property). In some embodiments, the selected content item is displayed within a portion of the interface or within an overlaying or pop-up interface associated with a rendering interface displayed on the device.

In some embodiments, the selected content item can be displayed as part of a coupon/ad clipping, coupon/ad recommendation and/or coupon/ad summarization interface.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, over a network by a computing device, from a device of a user executing a browser application, a request for a network resource;
accessing, by the computing device, an activity log for the user, the user activity log comprising information associated with a browser session of the user;
analyzing, by the computing device, the activity log, and identifying a set of actions performed by the user, the set of actions occurring during the browser session prior to the request for the network resource; and
analyzing, by the computing device, the set of actions, and determining a type of the actions, wherein,
when the type of actions correspond to login to a high-security property without an explicit logout by the user, authenticating the user to the network resource, and
when the type of actions correspond to non-logged in activity, requesting permission from the user to authenticate the user to the network resource.

2. The method of claim 1, wherein the authentication of the user to the network resource comprises authenticating a BCookie for network resource based on a BCookie for the high-security property.

3. The method of claim 1, further comprising:
receiving approval from the user to authenticate the network resource; and
authenticating a BCookie for the network resource.

4. The method of claim 1, wherein the non-logged in activity comprises a login to a high-security property and an explicit logout to the high-security property.

5. The method of claim 1, further comprising:
analyzing the request, and based on the analysis, determining a type of the requested network resource, wherein said access to the user activity log is based on said determination.

6. The method of claim 5, wherein the type of network resource is a high-security resource that requires a login to access its content.

7. The method of claim 6, further comprising:
determining a type of the browser session, the type of browser session being based on information related to the user device, wherein,
when the type of browser session is a private session, modifying a login page of the network resource by automatically checking a stay signed-in box by default, and
when the type of browser session is a shared session, modifying the login page by adding a private login option; and
communicating the modified login page to the device of the user for display within the browser.

8. The method of claim 7, wherein the login page is modified to remove the stay signed-in box such that a login via the modified login page is treated as if the stay signed-in box is checked.

9. The method of claim 5, wherein the type of network resource enables non-logged in users to access its content.

10. The method of claim 1, further comprising:
determining, based at least in part on analysis of the user activity log, that the user does not have an account with a service provider that provides the network resource;
identifying network information related to the user and the user device; and
creating a user profile based on the network information, the user profile corresponding to a virtual ID for the user, wherein when the user is detected on the network, the virtual ID is retrieved and used to track the user's network activity, wherein said tracking comprises storing BCookies for visited network resources to the user profile.

11. The method of claim 1, wherein said browser session of the user is a current browser session.

12. The method of claim 1, further comprising:
requesting, over the network, third party digital content based at least on information related to the browser session;
receiving, over the network, the third party digital content; and
communicating, over the network, the third party digital content to the user for display on a page of the network resource during the browser session.

13. A method comprising:
receiving, by a computing device over a network, a request for a network resource from a device of a user, the device executing an application to render pages of the network resource;
presenting, by the computing device, the pages of the network resource to the device, said presenting initiating a session start;
monitoring, by the computing device, activity of the user during the session on the network resource;
detecting, by the computing device, a session end to the activity;
issuing, by the computing device, a session token, the session token comprising information related to a predicted time of return to the network resource;
causing the device to pre-load data related to the session at a time proximate to the predicted return, the data related to the application and the pages of the network resource; and
determining whether the user returns to the network resource at a time within a threshold period of time relative to the predicted return defined by the session token, wherein,
when the return time is within the threshold period of time, authenticating the user, and
when the return time is outside the threshold period of time, requesting authentication.

14. The method of claim 13, further comprising:
identifying a set of account profiles for a set of users;
analyzing the account profiles, and based on said analysis:
determining device information for each user;
determining recency information for each user; and
determining frequency information for each user; and
applying a machine learning algorithm to the device information, recency information and frequency information, and determining predicted return information for the set of users, wherein the predicted return defined within the session token is based on the predicted return information.

15. A non-transitory computer-readable storage medium tangibly encoded with computer-executable instructions, that when executed by a processor associated with a computing device, performs a method comprising:
receiving, over a network by the computing device, from a device of a user executing a browser application, a request for a network resource;
accessing, by the computing device, an activity log for the user, the user activity log comprising information associated with a browser session of the user;
analyzing, by the computing device, the activity log, and identifying a set of actions performed by the user, the set of actions occurring during the browser session prior to the request for the network resource; and
analyzing, by the computing device, the set of actions, and determining a type of the actions, wherein,
when the type of actions correspond to login to a high-security property without an explicit logout by the user, authenticating the user to the network resource, and
when the type of actions correspond to non-logged in activity, requesting permission from the user to authenticate the user to the network resource.

16. The non-transitory computer-readable storage medium of claim 15, wherein the authentication of the user to the network resource comprises authenticating a BCookie for network resource based on a BCookie for the high-security property.

17. The non-transitory computer-readable storage medium of claim 15, further comprising:
receiving approval from the user to authenticate the network resource; and
authenticating a BCookie for the network resource.

18. The non-transitory computer-readable storage medium of claim 15, further comprising:
determining a type of the requested network resource, wherein when the type of network resource is a high-security resource that requires a login to access its content, the method further comprises:
determining a type of the browser session, the type of browser session being based on information related to the user device, wherein,
when the type of browser session is a private session, modifying a login page of the network resource by automatically checking a stay signed-in box by default, and
when the type of browser session is a shared session, modifying the login page by adding a private login option; and
communicating the modified login page to the device of the user for display within the browser.

19. The non-transitory computer-readable storage medium of claim 15, further comprising:
determining, based at least in part on analysis of the user activity log, that the user does not have an account with a service provider that provides the network resource;
identifying network information related to the user and the user device; and
creating a user profile based on the network information, the user profile corresponding to a virtual ID for the user, wherein when the user is detected on the network, the virtual ID is retrieved and used to track the user's network activity, wherein said tracking comprises storing BCookies for visited network resources to the user profile.

20. A computing device comprising:
a processor configured to:
receive, over a network, from a device of a user executing a browser application, a request for a network resource;
access an activity log for the user, the user activity log comprising information associated with a browser session of the user;
analyze the activity log, and identify a set of actions performed by the user, the set of actions occurring during the browser session prior to the request for the network resource; and
analyze the set of actions, and determine a type of the actions, wherein,
when the type of actions correspond to login to a high-security property without an explicit logout by the user, authenticate the user to the network resource, and
when the type of actions correspond to non-logged in activity, request permission from the user to authenticate the user to the network resource.
